(19) United States
(12) Patent Application Publication
(10) Pub. No.: US 2012/0051077 A1
(43) Pub. Date: Mar. 1, 2012

(54) VEHICULAR LAMP

(75) Inventor: Hajime Arai, Shizuoka (JP)

(73) Assignee: KOITO MANUFACTURING CO., LTD., Tokyo (JP)

(21) Appl. No.: 13/211,509

(22) Filed: Aug. 17, 2011

(30) Foreign Application Priority Data
Aug. 24, 2010 (JP) 2010-187270

(51) Int. Cl. F21V 7/00

(52) U.S. Cl. 362/516

(57) ABSTRACT

A vehicular lamp has a lamp chamber defined by an outer lens and a lamp body, a linear light guide arranged inside the lamp chamber, a light source provided facing a light incident end portion of the light guide, and a light guide attachment portion to which the linear light guide is mounted. Light emitted by the light source and incident on the light incident end portion is repeatedly internally reflected and guided toward another end portion such that a front surface side of a side surface of the light guide radiates light. The linear light guide is formed with a tongue-shaped extending portion that extends rearward parallel to an extending direction of the light guide. A side edge portion of the tongue-shaped extending portion is formed into a tapered shape in which a width of the extending portion narrows toward a distal end side thereof.

### BACKGROUND

1. Technical Field

The present invention relates to a vehicular lamp that is configured such that a linear light guide arranged inside a lamp chamber defined by an outer lens and a lamp body emits light.

2. Related Art

Among vehicular lamps such as clearance lamps and daytime running lamps for alerting the driver of an oncoming vehicle or other person to the presence of the host vehicle, generally in the past there have been types that use a reflector to reflect and distribute light from a light source, and types that use a lens step to diffuse and distribute light from a light source.

In recent years, a known type of vehicular lamp guides light from a light source to a linear light guide, and the light guide overall emits light. Among lamps of this type, as described in Patent Document 1 for example, there is a lamp that includes a linear light guide that is made of synthetic resin and arranged along a peripheral edge portion inside a lamp chamber, which is defined by an outer lens and a lamp body; and an LED that is a light source arranged on an end portion of the light guide.

[Patent Document 1]
Japanese Patent Application Laid-Open (Kokai) No. 2009-295552 (paragraph 0030, FIG. 2)

### SUMMARY

Patent Document 1 notes that known fixing means such as a screw or a hook is used to assemble the linear light guide, but there is no description at all regarding a specific attachment structure of the linear light guide.

In addition to the linear light guide extending in a long and thin manner, the lamp including the lamp chamber and the outer lens is configured to have a streamlined shape that follows the outer contour of the vehicle body. As a consequence, the linear light guide and light guide attachment portions on the lamp body side have complex three-dimensional shapes, and it can be assumed that an assembly process to mount the linear light guide at a predetermined location inside the lamp chamber is also complex.

One or more embodiments of the present invention provides a vehicular lamp in which a linear light guide is easily assembled.

A vehicular lamp according to one or more embodiments of the present invention includes a lamp chamber defined by an outer lens and a lamp body; a linear light guide arranged inside the lamp chamber; a light source provided facing a light incident end portion of the light guide; and a light guide attachment portion to which the linear light guide is mounted. Light of the light source that is incident from the light incident end portion is repeatedly internally reflected and guided toward another end portion side such that a front surface side of a side surface of the light guide radiates light. The vehicular lamp is characterized in that the linear light guide is formed with a tongue-shaped extending portion that extends rearward parallel to an extending direction of the light guide, and a side edge portion of the tongue-shaped extending portion is formed into a tapered shape in which a width of the extending portion narrows toward a distal end side thereof. The vehicular lamp is further characterized in that the light guide attachment portion is provided with an engagement portion for insertion of the tongue-shaped extending portion, and the tongue-shaped extending portion and the engagement portion are in recessed-projected lance engagement so as to fix the linear light guide to the light guide attachment portion.

(Operation) A distal end of the tongue-shaped extending portion whose side edge portion is formed into a tapered shape with a narrowed width towards the distal end side is correspondingly aligned so as to generally match the engagement portion (e.g., a through hole or a depression), and the light guide (extending portion) is pressed into (the engagement portion of) the light guide attachment portion. Thus, an inner peripheral edge of the engagement portion slides along the side edge portion of the extending portion, and each extending portion is smoothly inserted into the respective engagement portion. Accordingly, recessed-projected lance engagement portions provided among the extending portion and the engagement hole (a projected portion provided on one side, and a recessed portion provided on the other side) achieve recessed-projected lance engagement.

In particular, even if the linear light guide and the light guide attachment portion have complex three-dimensional curving shapes that follow the streamlined shape of the vehicle body, the tapered side edge portion can absorb a dimensional error between the extending portion and the engagement portion. This enables smooth insertion of the extending portion into the engagement portion and the recessed-projected lance engagement of both.

According to one or more embodiments of the present invention, the tongue-shaped extending portion is formed on either boundary between the front surface side and a back surface side of the side surface of the linear light guide.

(Operation) If the tongue-shaped extending portion is provided at a center portion of the back side surface of the side surface of the linear light guide, 1) a given section of the tongue-shaped extending portion will appear dark as a shadow when the lamp is not lit. And 2), because light distribution formation means such as stipples or reflective steps are generally provided on the back surface side of the light guide and the light distribution formation means cannot be formed at the given section formed with the extending portion, light emission when the lamp is lit is darker there compared to a surrounding area, and the light emission of the light guide at the given location is not uniform with other locations. However, if the tongue-shaped extending portion is provided on either boundary between the front surface side and the back surface side of the side surface of the linear light guide, there is no shadow when the lamp is not lit, and the reflective steps or the like are not used at the location formed with the tongue-shaped extending portion. Accordingly, there are no sections where the light emission appears dark.

According to one or more embodiments of the present invention, at least a base side of the side edge portion of the tongue-shaped extending portion is formed into a reverse tapered shape.

(Operation) According to the tongue-shaped extending portion of one or more embodiments of the present invention, although ability of the linear light guide to be assembled to the light guide attachment portion is good, the light of the light source incident from the light incident end portion is repeatedly internally reflected inside the light guide and progresses (is guided) toward the other end portion side such that the side surface of the light guide radiates light. However, if a portion of the guided light is guided to inside the tongue-shaped extending portion according to one or more embodiments of the present invention, as shown in FIG. 4, because a pair of side edge portions 52a, 52b of an extending portion 50 of a linear light guide 40a have a tapered shape in which a width of the extending portion 50 narrows toward the distal end side (the extending portion 50 has a tongue shape with a narrowed width toward the distal end side thereof), the light guided to inside the extending portion 50 is radiated (refracted) at a base portion 54 of the side edge portion 52b on the far side from a light incident end portion 43a. Thereafter, such light passes through a predetermined region of the light guide 40a near the base portion 54 and becomes light leakage L1 (indicated by a solid arrow) that heads toward an outer lens 4, or becomes light leakage L2 (indicated by a broken arrow) that is reflected or entirely reflected by an inner surface of the base portion 54 and heads toward the outer lens 4 from near the predetermined region.

Therefore, when viewing the light guide 40a from the front of the lamp, only a predetermined region R that corresponds to the light leakage location described above among a side surface 44 of the light guide 40a (hereinafter, “point lighting”) appears comparatively brighter than the surrounding area, which adversely affects an overall appearance while the lamp is lit.

However, among the pair of side edge portions 52a, 52b of the tongue-shaped extending portion 50, if at least the base portion 54 of the side edge portion 52b on the far side from the light incident end portion 43a is formed into a reverse tapered shape, as shown in FIG. 5, the light guided to the extending portion 50 becomes light leakage L3 (indicated by a solid arrow) that is radiated (refracted) rearward of the light guide 40a at the base portion 54 of the side edge portion 52b, or light leakage L4 (indicated by a broken arrow) that is reflected by the inner surface of the base portion 54 and radiated rearward of the light guide 40a. Therefore, light leakage toward the outer lens 4 from a predetermined position near the base portion 54 does not occur.

According to one or more embodiments of the present invention, on the side surface of the linear light guide, at least a boundary on a side opposite the boundary formed with the tongue-shaped extending portion is integrally formed with a projection portion that contacts a stepped portion formed on the light guide attachment portion.

(Operation) Among the boundaries between the front surface side and the back surface side of the side surface of the linear light guide, recessed-projected lance engagement is achieved on one boundary, and a distal end portion of the projection portion abuts against the stepped portion on the other boundary. Therefore, the linear light guide is also fixed in a manner that positions the linear light guide in a direction perpendicular to an insertion direction with respect to the light guide attachment portion.

According to one or more embodiments of the present invention, the light guide attachment portion is configured by an extension that is arranged between a light source unit of another lamp and the outer lens, the extension includes a linear opening portion and a linear reflector that is disposed rearward of the linear opening portion, and the linear light guide is attached and fixed to a front surface side of the linear reflector.

Specifically, the light guide attachment portion is configured by an extension that is arranged between the light source unit of another lamp and the outer lens, and the linear light guide is attached to the front surface side of the linear reflector disposed on a back surface side of the extension such that a front side surface of the linear light guide is exposed at the linear opening portion formed in the extension. Alternatively, the light guide attachment portion is configured such that the light guide is attached to the front surface side of the linear reflector integrally formed with the extension.

(Operation) Using the linear reflector included on the extension arranged between the light source unit of another lamp and the outer lens, light leakage from the tongue-shaped extending portion extending toward the rear of the lamp is reflected forward by the linear reflector extending toward the rear (back surface side) of the linear light guide, and returned again to inside the light guide. In addition, if the linear reflector is integrally formed with the extension, the number of parts can be correspondingly reduced.

Based on the above description, according to one or more embodiments of the present invention, a linear light guide can be surely mounted to a light guide attachment portion in a one-touch manner for easy assembly.

According to one or more embodiments of the present invention, forming a tongue-shaped extending portion does not interfere with a uniform light emission on a front surface side of a side surface of the linear light guide.

According to one or more embodiments of the present invention, point lighting caused by light leakage heading toward an outer lens is suppressed, and a front side surface of the linear light guide appears to overall uniformly radiate light. Therefore, a vehicular lamp with a high-quality outer appearance (good overall appearance) can be provided.

According to one or more embodiments of the present invention, the extending linear light guide is also fixed in a manner that positions the linear light guide in a direction perpendicular to an insertion direction. Therefore, instability caused by vibration does not occur.

According to one or more embodiments of the present invention, light leakage can be effectively utilized and not wasted.

Other aspects and advantages of the invention will be apparent from the following description, the drawings and the claims.

### BRIEF DESCRIPTION OF THE DRAWINGS

FIG. 1 is a frontal view of an automotive headlamp according to a first embodiment of the present invention.

FIG. 2 is a vertical cross-sectional view of the headlamp (cross-sectional view along a line II-II shown in FIG. 1).

FIG. 3 is a plane view of a linear light guide and a light source thereof.

FIG. 4 is an enlarged perspective view of a configuration of a fixing portion of the linear light guide as viewed from above, and a view that illustrates light leakage.

FIG. 5 is an enlarged perspective view of the fixing portion of the linear light guide according to the first embodiment as viewed from above, and a view that illustrates light leakage.

FIG. 6 is a frontal view of an automotive headlamp according to a second embodiment.

FIG. 7 is an enlarged perspective view of a fixing portion of a linear light guide of the headlamp as viewed from above, and a view that illustrates light leakage.

FIG. 8 is an enlarged perspective view of a fixing portion of a linear light guide according to a third embodiment as viewed from above, and a view that illustrates light leakage.

FIG. 9 is a vertical cross-sectional view of an automotive headlamp according to a fourth embodiment.

### DETAILED DESCRIPTION

Next, embodiments of the present invention will be described. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

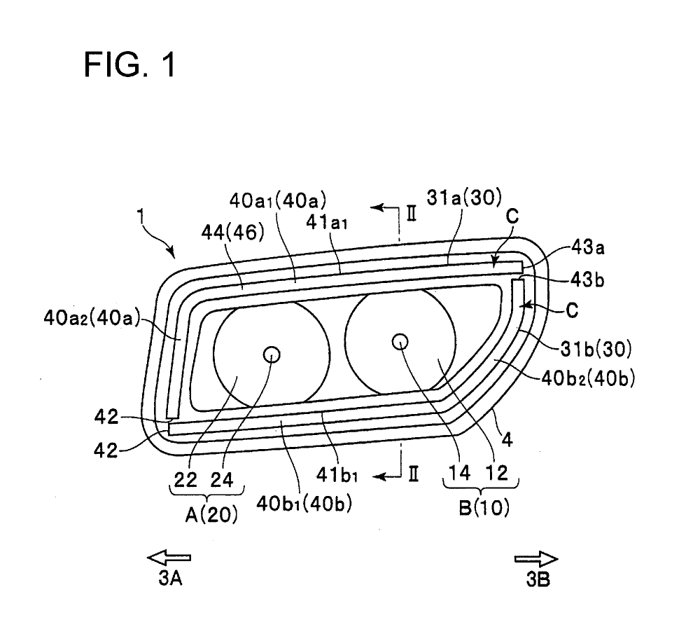

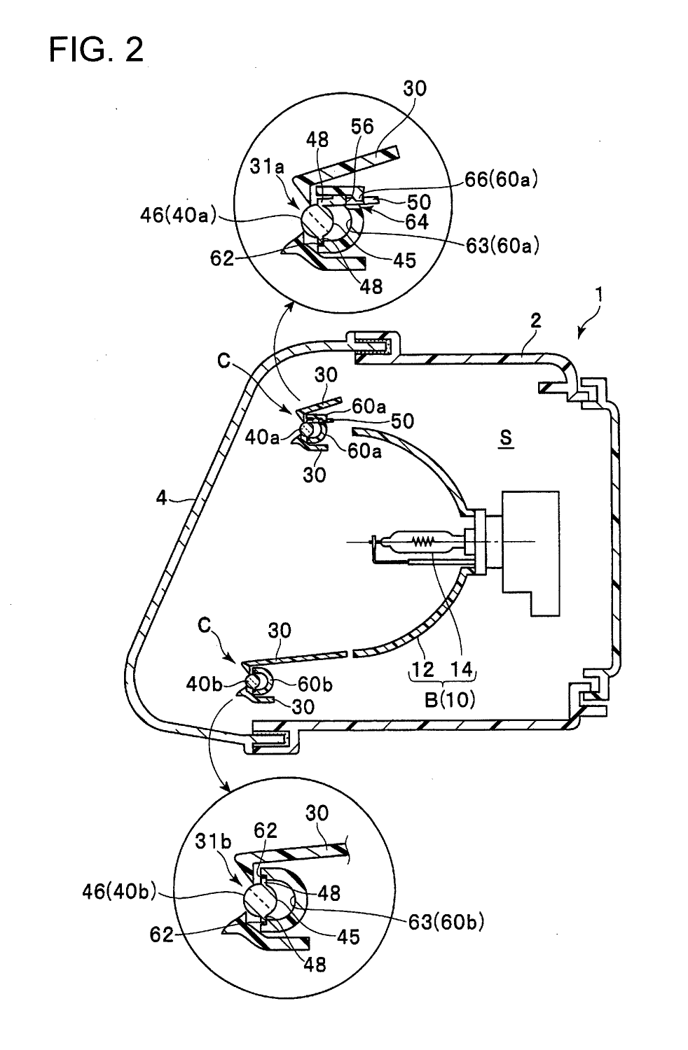

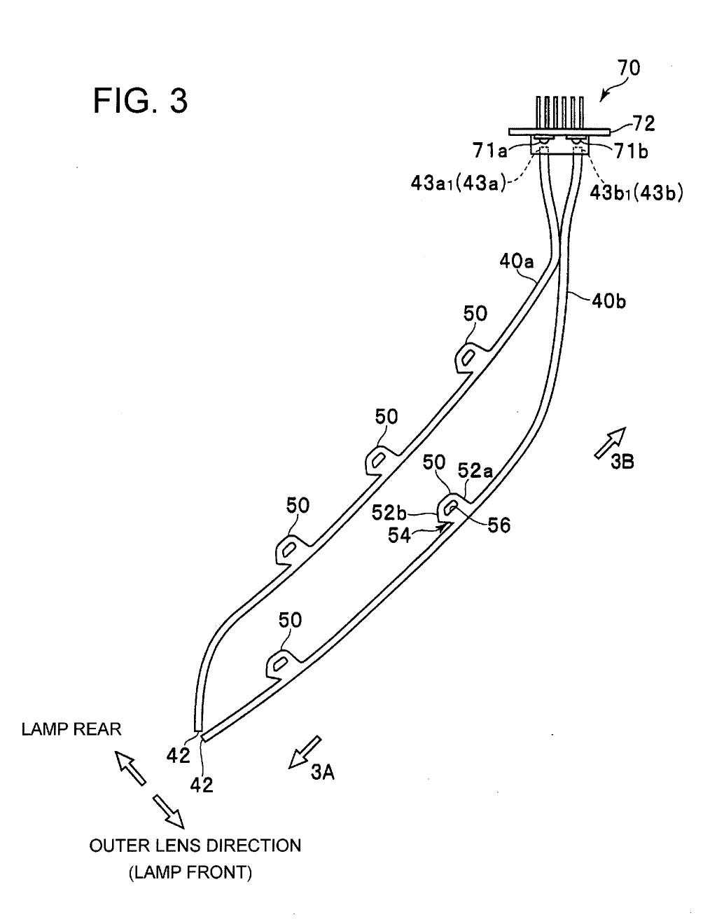

FIGS. 1 to 3 and FIG. 5 show an automotive headlamp according to a first embodiment of the present invention. FIG. 1 is a frontal view of the automotive headlamp according to the first embodiment of the present invention. FIG. 2 is a vertical cross-sectional view of the headlamp (cross-sectional view along a line II-II shown in FIG. 1). FIG. 3 is a plane view of a linear light guide and a light source thereof. FIG. 5 is an enlarged perspective view of a fixing portion of the linear light guide of the headlamp as viewed from above, and a view that illustrates light leakage. Note that the interior of a lamp chamber S visible through a transparent outer lens 4 is shown by a solid line in FIG. 1.

In these drawings, a vehicular headlamp 1 is a lamp provided on a right side as viewed from the vehicle front (left side as viewed from the driver seat). Reference numeral S is a lamp chamber of the headlamp 1 that is defined by a lamp body 2 and the transparent outer lens 4. A front opening portion of the lamp body 2 and the outer cover 4 are formed curving in a three-dimensional manner so as to wrap around from a vehicle front end portion 3A to a vehicle side 3B and follow the streamlined shape of the vehicle body.

Inside the lamp chamber S, a front turn signal lamp A is accommodated on a center vehicle front end portion 3A side, and a low beam lamp B is accommodated on a vehicle side 3B side. A daytime running lamp (nighttime clearance lamp) C is accommodated between the outer lens 4 and light source units 20, 10 of the lamps A, B. The daytime running lamp C is provided in a frame-like manner so as to surround the lamps A, B.

The low beam lamp B is configured by a reflective type of light source unit 10 that forms a predetermined low beam, wherein a discharge bulb 14 is insertedly mounted to a reflector 12 for low beam formation.

The front turn signal lamp A is configured by a reflective type of light source unit 20, wherein an incandescent bulb 24 is insertedly mounted to a reflector 22 with a general parabolic shape, and connected so as to flash in association with a direction indicator (not shown) provided at a front portion and/or a rear portion of the vehicle body in response to the operation of a direction indicator switch (not shown) provided within the vehicle body.

Further, inside the lamp chamber S, an extension 30 with an aluminized surface is provided on a front surface side of the light source units 10, 20 in order to hide a gap between the lamp body 2 and the respective light source units 20, 10 of the turn signal lamp A and the low beam lamp B described above.

The outer contour of the extension 30 is formed in a generally oblong shape as viewed from the front that follows the front opening portion of the lamp body 2. The extension 30 is fixed by a screw to the outer lens 4, for example, so as to be positioned and held inside the lamp chamber S. Linear opening portions 31a, 31b are formed in the extension 30 and have generally the same shape when viewed from the front as light guides 40a, 40b that configure the daytime running lamp C. The linear opening portions 31a, 31b respectively expose front surface sides 46 of side surfaces 44 of the linear light guides 40a, 40b. The light guides 40a, 40b are assembled from a back surface side of the extension 30 (via linear reflectors 60a, 60b described later).

Next, the configuration of the daytime running lamp C will be described in detail.

The daytime running lamp C is configured by the two linear light guides 40a, 40b, which are made of a transparent synthetic resin (e.g., acrylic resin) and have generally circular cross sections. An LED unit assembly 70 is provided at a predetermined position on the vehicle side 3B side at the rear of the lamp chamber S interior. The LED unit assembly 70 accommodates LEDs 71a, 71b that serve as light sources of the linear light guides 40a, 40b.

The linear light guide 40a has an end portion 43a that is one end among both ends of the extending linear light guide 40a and connected to the LED unit assembly 70, and the linear light guide 40a is provided upward and toward the left side when the inside of the lamp chamber S is viewed from the front. Specifically, the linear light guide 40a is connected such that the LED 71a mounted on a front surface side of a printed board 72 of the LED unit assembly 70 faces an end surface 43a1 of the end portion 43a of the light guide 40a, and an illumination axis of the LED 71a is perpendicular to the end surface 43a1. The linear light guide 40a is formed between the outer lens 4 and the light source units 10, 20 from an upper portion 40a1 that is arranged in a generally linear fashion on an upper side of the light source units 10, 20 extending from the vehicle side 3B side to the vehicle front end portion 3A side, and a left portion 40a2 that is arranged in a generally linear fashion on the vehicle front end portion 3A side.

The linear light guide 40b is connected such that an illumination axis of the LED 71b on the front surface side of the printed board 72 is perpendicular to an end surface 43b1 of an end surface 43b of the light guide 40b. The linear light guide 40b is similarly formed from a right portion 40a2 that is arranged on the vehicle side 3B side, and a lower portion 40a1 that is arranged generally below the light source units 10, 20 extending from the vehicle side 3B side toward the vehicle front end portion 3A side. In the description below, the end portion 43a and the end portion 43b on the sides provided with the LEDs 71a, 71b that are light sources are referred to as “light incident end portions”.

The linear light guides 40a, 40b are also formed curving in a three-dimensional manner so as to wrap around from the vehicle front end portion 3A to the vehicle side 3B and follow the streamlined shape of the outer lens 4 (see FIG. 3).

Reflective steps 47 (not shown) formed by prism-like grooves are provided at a predetermined pitch generally over an entire area of respective back surface sides (hereinafter, “back surface sides 45”) of the side surfaces 44 of the linear light guides 40a, 40b. Guided light that enters from the light incident end portions 43a, 43b is reflected by the reflective steps 47, and radiated forward from respective front surface sides (hereinafter, “front surface sides 46”) of the side surfaces 44 of the light guides 40a, 40b in a generally uniform manner.

In addition, on the respective side surfaces 44 of the linear light guides 40a, 40b, ribs 48 are integrally formed at a boundary between the front side surfaces 46 and the back side surfaces 45 of the light guides 40a, 40b, except at the light incident end portions 43a, 43b (see FIG. 2; note that the ribs 48 are not shown in FIG. 3). Each rib 48 has an oblong cross section, and contacts a stepped portion 62 formed on a linear reflectors 60a, 60b described later.

Tongue-shaped extending portions 50 for assembling the light guides 40a, 40b to light guide attachment portions described later are also formed on the linear light guides 40a, 40b. The tongue-shaped extending portion 50 is provided at three generally equidistant locations on the upper end portion 41a1 of the upper portion 40a1 of the linear light guide 40a, and at two generally equidistant locations on the upper end portion 41b1 of the lower portion 40b1 of the linear light guide 40b (see FIG. 3).

Next, the configuration of the tongue-shaped extending portion 50 will be described using the linear light guide 40a as an example. As shown in FIG. 5, the tongue-shaped extending portion 50 is a generally plate-shaped fixing portion that extends from the rib 48 on the upper end portion 41a1 side of the upper portion 40a1 of the light guide 40a toward the lamp rear parallel to the extending direction of the light guide 40a.

A pair of side edge portions 52a, 52b of the tongue-shaped extending portion 50 are integrally formed into a tapered shape in which the width of the extending portion 50 narrows toward a distal end side (lamp rear side). The side edge portion 52b on the far side from the light incident end portion 43a has a base side (hereinafter, a “base portion 54”) that is formed as a reverse taper (a tapered shape in which the width of the extending portion 50 narrows toward the base side (lamp front side)).

A lance hole 56 having a generally oblong shape that can be engaged with a hook portion 66 of a linear reflector 60a described later is formed at a generally center portion of the tongue-shaped extending portion 50.

Note that, from the standpoint of attachability to the light guide attachment portion, the tongue-shaped extending portions 50 may also be provided at a center portion of the back side surface 45 of the linear light guide 40a. However, 1) a given section of the tongue-shaped extending portion 50 will appear dark as a shadow when the lamp is not lit. And 2), because the reflective steps 47 cannot be formed at the given section, light emission when the lamp is lit is darker than at the front side surface 46, and the light emission of the light guide 40a at the given location is not uniform with other locations. Accordingly, according to one or more embodiments of the present invention, the tongue-shaped extending portions 50 are provided on either boundary between the front side surface 46 and the back side surface 45 of the light guide 40a (at positions that generally correspond to the top or bottom of the circular cross section).

In addition, although the tongue-shaped extending portions 50 extend from the rib 48 on the upper end side, the tongue-shaped extending portions 50 may be formed directly extending from the upper end of the light guide 40a body which would have somewhat less light emission.

Next, the linear reflector 60a that is the attachment portion for the linear light guide 40a will be described. The linear reflector 60a has a semicircular arc-shaped cross section, and is an optical member that extends in a linear fashion and has generally the same shape as the light guide 40a when viewed from the front. The linear reflector 60a is assembled and integrated into the extension 30.

A front surface 63 side of the linear reflector 60a is aluminized and embossed, and light reflected by the front surface 63 is distributed so as to head forward of the lamp. In addition, the stepped portion 62 where a distal end and a back surface side of the rib 48 formed on the linear light guide 40a are engaged is provided extending at positions that generally correspond to the top and bottom of the semicircular cross section of the linear reflector 60a.

An engagement hole 64 having an oblong shape and inserted with the tongue-shaped extending portion 50 is provided at positions that correspond to the tongue-shaped extending portions 50. The hook portion 66, which is in recessed-projected lance engagement with the lance hole 56 of the tongue-shaped extending portion 50, is formed on an inner periphery (upper surface) of the engagement hole 64 so as to project downward.

A linear reflector 60b has generally the same shape as the linear light guide 40b. Excluding the fact that the engagement hole 64 is provided at the two locations mentioned earlier, the linear reflector 60b is otherwise similar to the linear reflector 60a.

Next, a process to assemble the linear light guide 40a to the linear reflector 60a will be described.

The distal ends of the tongue-shaped extending portions 50 of the linear light guide 40a are aligned so as to generally match the corresponding engagement holes 64 of the linear reflector 60a. The linear light guide 40a is (the tongue-shaped extending portions 50 are) pressed into (the engagement holes 64 of) the linear reflector 60a. Thus, inner peripheral side edges of the engagement holes 64 slide along (the distal end sides of) the side edge portions 52a, 52b of the tongue-shaped extending portions 50, whereby the tongue-shaped extending portions 50 are smoothly inserted into the engagement holes 64.

Once the lance holes 56 provided in the tongue-shaped extending portions 50 are inserted up to positions that correspond to the hook portions 66 provided on the engagement holes 64, the hook portions 66 automatically achieve a recessed-projected lance engagement with the lance holes 56, and the tongue-shaped extending portions 50 are surely held by the linear reflector 60a so as not to detach in a front-rear direction. In addition, the distal ends and the back surface sides of the ribs 48 provided on both ends of the side surface 44 of the light guide 40a abut against the stepped portions 62 of the linear reflector 60a, and the light guide 40a is fixed in a manner that positions the light guide 40a in a direction perpendicular to the front-rear direction (insertion direction). Therefore, instability caused by vibration does not occur.

In this case, by simply aligning the tongue-shaped extending portions 50 and the engagement holes 64 so as to generally match and then pressing the linear light guide 40a into the linear reflector 60a, the linear light guide 40a can be easily mounted in a one-touch manner and assembly of the linear light guide 40a is made simple.

In particular, even if the linear light guide 40a and the linear reflector 60a have complex three-dimensional curving shapes that follow the streamlined shape of the vehicle body, the tapered side edge portions 52a, 52b can absorb a dimensional error between the tongue-shaped extending portion 50 and the engagement hole 64. This enables extremely smooth insertion of the tongue-shaped extending portion 50 into the engagement hole 64 and the recessed-projected lance engagement of both.

Based on the above, the linear light guide 40a is surely fixed and held to the front surface side of the linear reflector 60a with the entire back side surface 45 covered by the reflector 60a.

Next, the linear reflector 60a to which the linear light guide 40a is mounted is inserted from the back surface side of the extension 30, and the extension 30 and the reflector 60a are fixed by commonly known means such as a screw at a predetermined location such that the front side surface 46 of the linear light guide 40a is exposed at the linear opening portion 31a. Thus, arrangement of the linear light guide 40a is complete. The linear reflector 60b in recessed-projected lance engagement with the linear light guide 40b is similarly fixed to the extension 30 so as to be exposed at the linear opening portion 31b, thus completing assembly of the daytime running lamp C.

Next, light guiding and light leakage will be described using the linear light guide 40a as an example.

Light of the LED 71a that enters from the light incident end portion 43a is repeatedly internally reflected inside the linear light guide 40a and guided toward the other end portion 42. Such light is also reflected by the reflective steps 47 provided over the entire back side surface 45 of the light guide 40a, and radiated from the front side surface 46 of the light guide 40a. However, a portion of the guided light is also guided to inside the tongue-shaped extending portion 50.

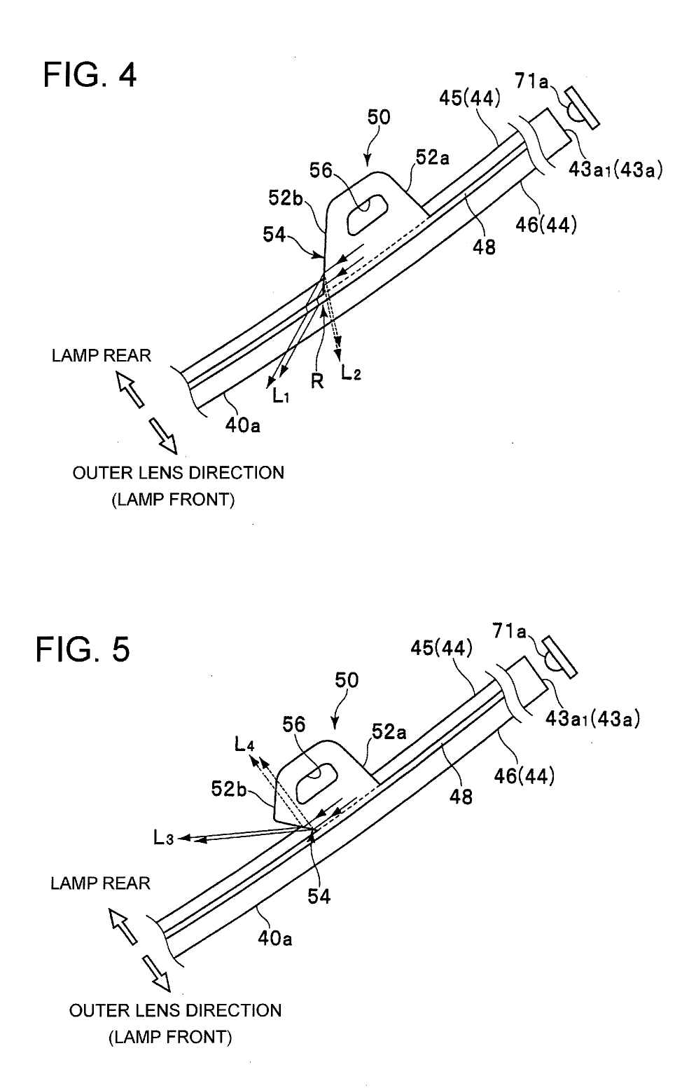

Here, as shown in FIG. 4, the tongue-shaped extending portion 50 of the linear light guide 40a is formed with the side edge portions 52a, 52b having a tapered shape in which the width of the extending portion 50 narrows toward the distal end side (a tongue shape in which the extending portion 50 has a narrower width toward the distal end side thereof). Therefore, a majority of the light guided to inside the extending portion 50 is radiated (refracted) toward the light guide 40a side at the base portion 54 of the side edge portion 52b on the far side from the light incident end portion 43a. Thereafter, such light passes through a predetermined region of the rib 48 near the base portion 54 and is refracted again. The light then becomes light leakage L1 (indicated by a solid arrow) that heads toward the outer lens 4. Another portion of such light is reflected or entirely reflected by an inner surface of the base portion 54 and becomes light leakage L2 (indicated by a broken arrow) that heads toward the outer lens 4 from the rib 48 near the predetermined region.

Therefore, when viewing the light guide 40a from the front of the lamp, only a predetermined region R of the rib 48 that corresponds to the light leakage location described above (hereinafter, “point lighting”) appears comparatively brighter than the surrounding front side surface 46, which adversely affects an overall appearance while the lamp is lit.

However, in the first embodiment as shown in FIG. 5, among the pair of side edge portions 52a, 52b of the tongue-shaped extending portion 50, the base portion 54 of the side edge portion 52b on the far side from the light incident end portion 43a has a reverse tapered shape (a tapered shape in which the width of the extending portion 50 narrows toward the base 54 side (lamp front side)). Therefore, the majority of light guided to the extending portion 50 becomes light leakage L3 (indicated by a solid arrow) that is radiated (refracted) rearward of the light guide 40a at the base portion 54 of the side edge portion 52b. Alternatively, such light is reflected by the inner surface of the base portion 54 and becomes light leakage L4 (indicated by a broken arrow) that is radiated rearward of the light guide 40a. Thus, the leakage of light toward the outer lens 4 does not occur.

Therefore, the point lighting of the region R is suppressed, and when viewed from the lamp front, the entire front side surface 46 of the linear light guide 40a that is exposed (at the linear opening portion 31a) on the extension 30 appears to uniformly radiate light. Consequently, the headlamp 1 achieves a high-quality outer appearance (good overall appearance).

Further, the light leakage L3, L4 toward the rear of the lamp is distributed so as to be reflected forward of the lamp by the front surface 63 of the linear reflector 60a provided on the back surface side of the light guide 40a, and thus returned again to inside the light guide 40a. Therefore, the light leakage L3, L4 is effectively utilized and not wasted.

### Second Embodiment

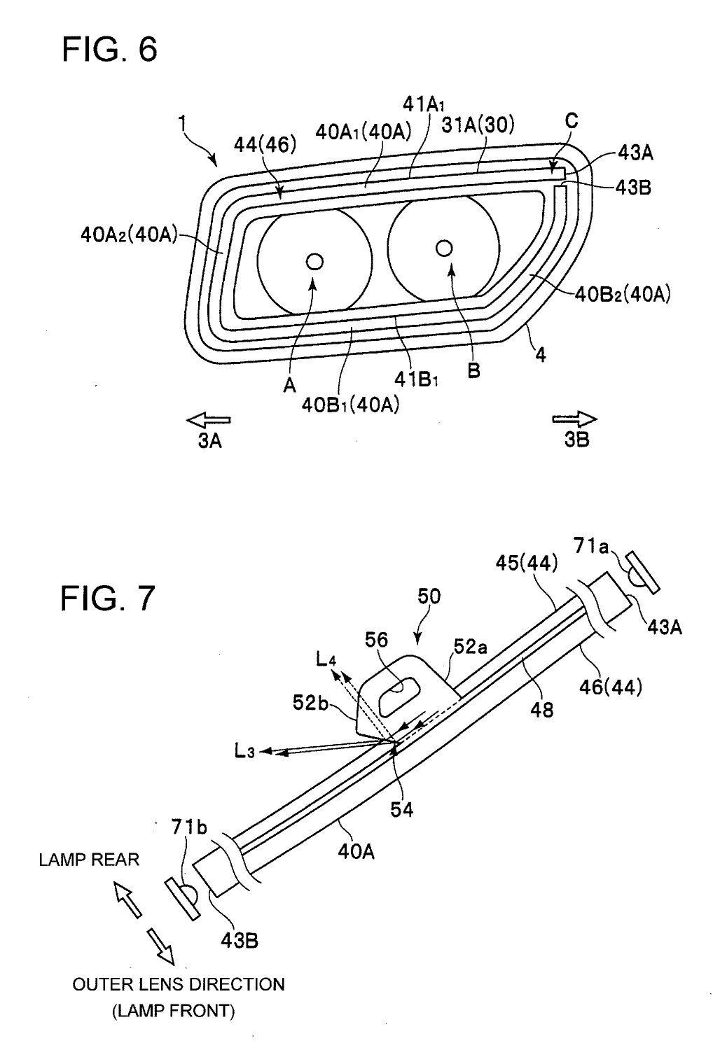

FIGS. 6 and 7 show a second embodiment of the present invention. FIG. 6 is a frontal view of an automotive headlamp according to the second embodiment, and FIG. 7 is an enlarged perspective view of a fixing portion of a linear light guide of the headlamp as viewed from above, and a view that illustrates light leakage.

According to the second embodiment, the daytime running lamp C is configured by one linear light guide 40A at a position generally similar to that of the first embodiment. In addition, the shapes of a linear reflector 60A and a linear opening portion 31A are modified to follow the shape of the light guide 40A as viewed from the front of the light guide 40A. Otherwise, the second embodiment is identical in constitution to the first embodiment. The process to assemble the linear light guide 40A is also similar to that of the first embodiment.

However, the linear light guide 40A is configured such that light from the light sources enters from both end portions 43A, 43B of the one light guide 40A. Therefore, the light of the LED 71a that enters from the light incident end portion 43A is repeatedly internally reflected and at the same time guided to the light incident end portion 43B, and the light of the LED 71b is guided to the light incident end portion 43A from the light incident end portion 43B.

Thus, with regard to the tongue-shaped extending portions 50 provided on an upper portion 40A1 of the light guide 40A, as shown in FIG. 7, guided light from the LED 71a that enters from the light incident end portion 43A near a given extending portion 50 is radiated rearward of the light guide 40A by the base portion 54 of the side edge portion 52b (becomes the light leakage L3, L4) similar to the first embodiment. Consequently, such light does not leak in the direction of the outer lens 4.

Meanwhile, guided light from the LED 71b that enters from the light incident end portion 43B far from the extending portion 50 is blocked from entering the extending portion 50 because the base portion 54 of the reverse-tapered side edge portion 52b acts as a partition with respect to the direction of incidence to the tongue-shaped extending portion 50. Consequently, such light is internally reflected and guided without change inside the light guide 40A. This reduces the amount of light from the LED 71b incident to the tongue-shaped extending portion 50. Even if a minute amount of light from the LED 71b that entered the tongue-shaped extending portion 50 leaks toward the outer lens 4 from the side edge portion 52a, point lighting of the rib 48 near the side edge portion 52a does not occur because the amount is so small.

Likewise, with regard to the tongue-shaped extending portions 50 provided on a lower portion 40B1 of the light guide 40A, the light of the LED 71b from the light incident end portion 43B near a given extending portion 50 is radiated (leaked) to rearward of the light guide 40A at the side edge portion 52b, and incidence of the light of the LED 71a from the far light incident end portion 43A is suppressed by the base portion 54 of the side edge portion 52b. Thus, point lighting does not occur.

Accordingly, forming the base portion 54 of the side edge portion 52b into a reverse tapered shape has a sufficient effect even in cases where the light of a light source enters from both ends of one light guide.

### Third Embodiment

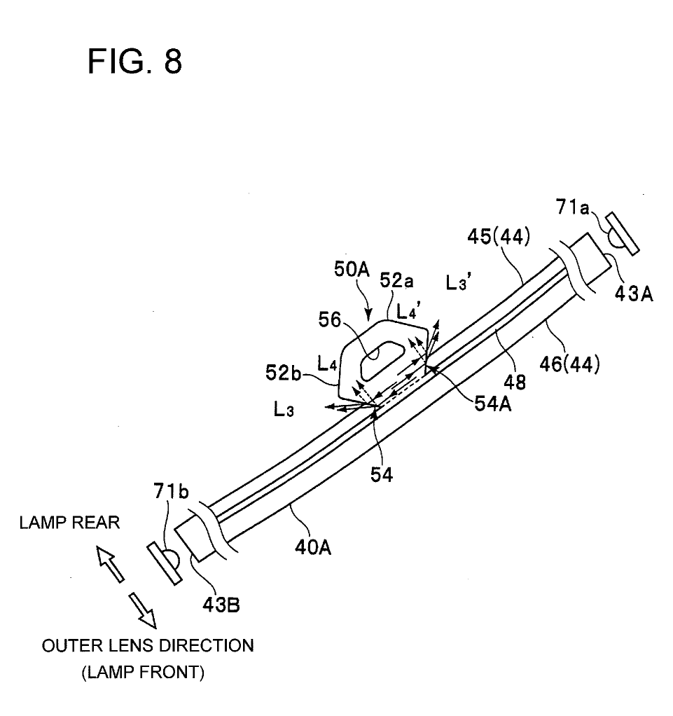

FIG. 8 is an enlarged perspective view of a fixing portion of a linear light guide according to a third embodiment of the present invention as viewed from above, and a view that illustrates light leakage.

In the third embodiment, the shape of the tongue-shaped extending portion 50 of the second embodiment is modified into a tongue-shaped extending portion 50A. Otherwise, the third embodiment is identical to the second embodiment.

As shown in FIG. 8, the tongue-shaped extending portion 50A has a shape in which, in addition to the side edge portion 52b, a base portion 54A of the side edge portion 52a is reverse-tapered.

Thus, with regard to guided light in the tongue-shaped extending portion 50A, using the tongue-shaped extending portion 50A provided on the upper portion 40A1 of the light guide 40A in this description, guided light from the LED 71a that enters from the light incident end portion 43A near the extending portion 50A is also blocked from entering the extending portion 50A because the base portion 54A of the reverse-tapered side edge portion 52a acts as a partition, and such light is repeatedly internally reflected and guided without change inside the light guide 40A. The same holds true for guided light of the LED 71b that enters from the light incident end portion 43B far from the extending portion 50A. This significantly reduces the amount of light incident to the tongue-shaped extending portion 50A. Even if a minute amount of light from the LEDs 71a, 71b enters the tongue-shaped extending portion 50A, the light of the LED 71a is radiated (refracted) rearward of the lamp by the base portion 54 of the side edge portion 52b (becoming L3, L4), and the light of the LED 71b is radiated (refracted) rearward of the lamp by the base portion 54A of the side edge portion 52a (becoming L3′, L4′). Therefore, light leakage toward the outer lens 4 does not occur at all. Consequently, point lighting can be reliably controlled.

Note that the tongue-shaped extending portion 50A of the third embodiment may also be used in the first embodiment.

### Fourth Embodiment

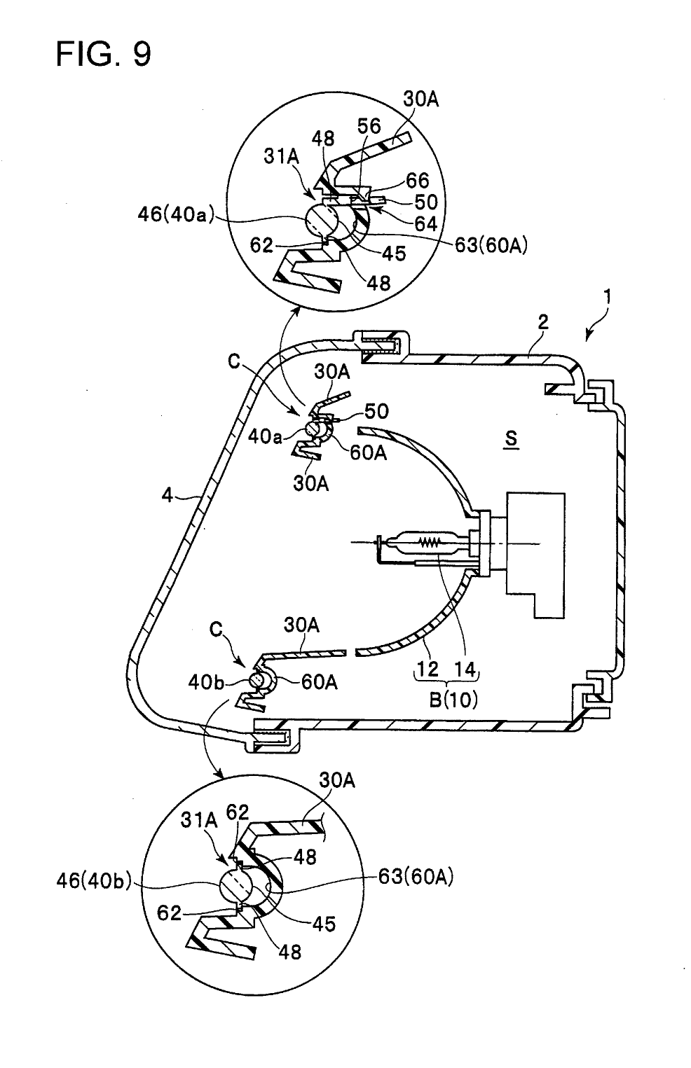

FIG. 9 is a vertical cross-sectional view of an automotive headlamp according to a fourth embodiment of the present invention.

According to the fourth embodiment, the extension 30 and the linear reflectors 60a, 60b that were separate members in the first embodiment are integrated, and an extension 30A in which a linear reflector portion 60A is formed on the front surface of the extension 30 acts as the light guide attachment portion. Otherwise, the fourth embodiment is identical in constitution to the first embodiment.

As shown in FIG. 9, the extension 30A is configured such that the linear reflector 60A is integrally formed on a front surface of the extension 30A. In the linear reflector 60A, a section that corresponds to the linear opening portions 31a, 31b of the extension 30 in the first embodiment is a linear groove portion that recesses rearward of the lamp so as to have a semicircular arc-shaped cross section, and the groove portion is aluminized and embossed so that the linear reflector 60A distributes reflected light forward of the lamp.

Similar to the first embodiment, the engagement holes 64, the hook portions 66, and the stepped portions 62 are provided on the linear reflector 60A (extension 30A). By aligning the tongue-shaped extending portions 50 of the linear light guides 40a, 40b so as to generally match the engagement holes 64 and pressing the tongue-shaped portions 50 into the engagement holes 64, both achieve a recessed-projected lance engagement, whereby the light guides 40a, 40b are easily mounted to the extension 30A. In addition, the light guides 40a, 40b are surely fixed and held on a front surface side of the linear reflector 60A with the entire back side surfaces 45 covered by the linear reflector 60A and the front side surfaces 46 exposed at linear opening portions 31A.

According to the fourth embodiment, light leakage in the tongue-shaped extending portions 50 toward the rear of the lamp is reflected forward of the lamp by the front surface 63 of the linear reflector portion 60A arranged on the back surface sides of the light guides 40a, 40b, and thus returned again to inside the light guides 40a, 40b. Therefore, similar to the first embodiment, light leakage can be effectively utilized and not wasted.

Further, with the linear reflector portion 60A integrally formed with the extension 30A, the third embodiment succeeds in reducing the number of parts accordingly compared to the first embodiment, and a correspondingly simpler structure around the linear light guides 40a, 40b is also achieved.

Note that the extension 30A may also be used in the second and third embodiments.

The configuration of the first to fourth embodiments described above is not limited provided that a tongue-shaped extending portion of a linear light guide and a light guide attachment portion (extension provided with an integrated or separate linear reflector) are fixed to each other by recessed-projected lance engagement. For example, a projected portion (hook portion 66) and a recessed portion (lance hole 56) may be provided on either the tongue-shaped extending portion of the linear light guide or the light guide attachment portion, and the recessed portion may also be a depression rather than the lance hole 56.

The tongue-shaped extending portions may be provided on respective left portions and right portions of the linear light guides. However, at locations provided with the engagement holes 64, the holes may appear somewhat dark through the outer lens. Therefore, according to one or more embodiments of the present invention, from the standpoint of the overall appearance of the lamp, the tongue-shaped extending portions are provided on the respective upper portions and lower portions of the light guides so that the engagement holes 64 are not easily seen by a person looking down at the lamp. In particular, according to one or more embodiments of the present invention, among positions on the upper portions and lower portions that generally correspond to the top and bottom of the circular cross sections of the light guides, the tongue-shaped extending portions are provided on the top portions of the circular cross sections.

The reverse taper of the side edge portion of the tongue-shaped extending portions described earlier is not limited in any manner provided that at least a base side of the side edge portion is reverse-tapered.

Note that even if one of the side edge portions 52a, 52b of the tongue-shaped extending portions described earlier has a vertical form (a non-tapered shape), so long as one side edge portion is tapered to have a narrowed width toward the distal end side thereof, such tapered tongue shapes are obviously included in the idea of a shape whose width narrows toward the distal end side.

In addition, the shape of the cross section of the linear light guide may also be an elliptical shape or an oblong oval.

Also, as light distribution forming means provided on the linear light guide, stipples may be used instead of the reflective steps 47.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### DESCRIPTION OF THE REFERENCE NUMERALS

1 VEHICULAR HEADLAMP
2 LAMP BODY
4 OUTER LENS
3A VEHICLE FRONT END PORTION
3B VEHICLE SIDE
A TURN SIGNAL LAMP
B LOW BEAM LAMP
C DAYTIME RUNNING LAMP
30, 30A EXTENSION
31a, 31b, 31A LINEAR OPENING PORTION OF EXTENSION
40a, 40b, 40A LINEAR LIGHT GUIDE
43a, 43b, 43A, 43B LIGHT INCIDENT END PORTION
45 BACK SIDE SURFACE OF LINEAR LIGHT GUIDE
46 FRONT SIDE SURFACE OF LINEAR LIGHT GUIDE
48 RIB
50, 50A TONGUE-SHAPED EXTENDING PORTION
52a SIDE EDGE PORTION OF LIGHT INCIDENT END PORTION SIDE
52b SIDE EDGE PORTION OF FAR SIDE FROM LIGHT INCIDENT END PORTION
54, 54A BASE PORTION OF SIDE EDGE PORTION
56 RECESSED-PROJECTED LANCE HOLE
60a, 60b, 60A LINEAR REFLECTOR
62 STEPPED PORTION
64 ENGAGEMENT HOLE OF EXTENDING PORTION
66 HOOK PORTION
71a, 71b LED (LIGHT SOURCE OF LINEAR LIGHT GUIDE)
R Point Light Region

1. A vehicular lamp comprising:
a lamp chamber defined by an outer lens and a lamp body;
a linear light guide arranged inside the lamp chamber;
a light source provided facing a light incident end portion of the light guide; and
a light guide attachment portion to which the linear light guide is mounted,
wherein light emitted by the light source and incident on the light incident end portion is repeatedly internally reflected and guided toward another end portion such that a front surface side of a side surface of the light guide radiates light,
wherein the linear light guide is formed with a tongue-shaped extending portion that extends rearward parallel to an extending direction of the light guide,
wherein a side edge portion of the tongue-shaped extending portion is formed into a tapered shape in which a width of the extending portion narrows toward a distal end side thereof,
wherein the light guide attachment portion is provided with an engagement portion for insertion of the tongue-shaped extending portion, and
wherein the tongue-shaped extending portion and the engagement portion are in recessed-projected lance engagement so as to fix the linear light guide to the light guide attachment portion.

2. The vehicular lamp according to claim 1, wherein the tongue-shaped extending portion is formed on either boundary between the front surface side and a back surface side of the side surface of the linear light guide.

3. The vehicular lamp according to claim 1, wherein at least a base side of the side edge portion of the tongue-shaped extending portion is formed into a reverse tapered shape.

4. The vehicular lamp according to claim 2, wherein, on the side surface of the linear light guide, at least a boundary on a side opposite the boundary formed with the tongue-shaped extending portion is integrally formed with a projection portion that contacts a stepped portion formed on the light guide attachment portion.

5. The vehicular lamp according to claim 1,
wherein the light guide attachment portion is configured by an extension that is arranged between a light source unit of another lamp and the outer lens,
wherein the extension comprises a linear opening portion and a linear reflector that is disposed rearward of the linear opening portion, and
wherein the linear light guide is attached and fixed to a front surface side of the linear reflector.

6. The vehicular lamp according to claim 2, wherein at least a base side of the side edge portion of the tongue-shaped extending portion is formed into a reverse tapered shape.

7. The vehicular lamp according to claim 3, wherein, on the side surface of the linear light guide, at least a boundary on a side opposite the boundary formed with the tongue-shaped extending portion is integrally formed with a projection portion that contacts a stepped portion formed on the light guide attachment portion.

8. The vehicular lamp according to claim 2,
wherein the light guide attachment portion is configured by an extension that is arranged between a light source unit of another lamp and the outer lens,
wherein the extension comprises a linear opening portion and a linear reflector that is disposed rearward of the linear opening portion, and
wherein the linear light guide is attached and fixed to a front surface side of the linear reflector.

9. The vehicular lamp according to claim 3,
wherein the light guide attachment portion is configured by an extension that is arranged between a light source unit of another lamp and the outer lens,
wherein the extension comprises a linear opening portion and a linear reflector that is disposed rearward of the linear opening portion, and
wherein the linear light guide is attached and fixed to a front surface side of the linear reflector.

10. The vehicular lamp according to claim 4,
wherein the light guide attachment portion is configured by an extension that is arranged between a light source unit of another lamp and the outer lens,
wherein the extension comprises a linear opening portion and a linear reflector that is disposed rearward of the linear opening portion, and
wherein the linear light guide is attached and fixed to a front surface side of the linear reflector.

11. The vehicular lamp according to claim 6, wherein, on the side surface of the linear light guide, at least a boundary on a side opposite the boundary formed with the tongue-shaped extending portion is integrally formed with a projection portion that contacts a stepped portion formed on the light guide attachment portion.

12. The vehicular lamp according to claim 6,
wherein the light guide attachment portion is configured by an extension that is arranged between a light source unit of another lamp and the outer lens,
wherein the extension comprises a linear opening portion and a linear reflector that is disposed rearward of the linear opening portion, and
wherein the linear light guide is attached and fixed to a front surface side of the linear reflector.

13. The vehicular lamp according to claim 7,
wherein the light guide attachment portion is configured by an extension that is arranged between a light source unit of another lamp and the outer lens,
wherein the extension comprises a linear opening portion and a linear reflector that is disposed rearward of the linear opening portion, and
wherein the linear light guide is attached and fixed to a front surface side of the linear reflector.

14. The vehicular lamp according to claim 11,
wherein the light guide attachment portion is configured by an extension that is arranged between a light source unit of another lamp and the outer lens,
wherein the extension comprises a linear opening portion and a linear reflector that is disposed rearward of the linear opening portion, and
wherein the linear light guide is attached and fixed to a front surface side of the linear reflector.
